(19) United States
(12) Patent Application Publication
(10) Pub. No.: US 2014/0311574 A1
(43) Pub. Date: Oct. 23, 2014

(54) Self-Aligned Deposition of Silica Layers for Dye-Sensitized Solar Cells

(71) Applicant: President and Fellows of Harvard College, Cambridge, MA (US)

(72) Inventor: Roy Gerald Gordon, Cambridge, MA (US)

(21) Appl. No.: 14/357,065

(22) PCT Filed: Nov. 19, 2012
(86) PCT No.: PCT/US2012/065781

§ 371 Date: May 8, 2014

Related U.S. Application Data
(60) Provisional application No. 61/562,265, filed on Nov. 21, 2011.

(51) Int. Cl. H01G 9/20; H01G 9/00

(52) U.S. Cl. CPC H01G 9/2031; H01G 9/0029
USPC 136/261; 438/85

(57) ABSTRACT

The application is directed to improved dye-sensitized solar cells and methods for making the same. In accordance with certain embodiments, dye-sensitized anodes are exposed to a vapor including at least one chemical that reacts with the catalytically active material of the anode to deposit a silica layer only on regions that are not covered with the dyes. The resulting self-aligned silica layers provide increased efficiency for dye-sensitized solar cells by reducing the leakage current from the anode to the electrolyte.

### CROSS-REFERENCE TO RELATED APPLICATIONS

This application claims priority to U.S. Provisional Patent Application No. 61/562,265 filed Nov. 21, 2011 which is hereby incorporated by reference in its entirety.

### BACKGROUND

This invention relates to the self-aligned deposition of silica for increasing the conversion efficiency of dye-sensitized solar cells.

Silica, otherwise known as silicon dioxide, with chemical formula SiO₂, is a common component of sand and other minerals. Silica has many useful properties, including excellent electrical insulating ability, high transparency to light, resistance to corrosion by many chemicals, mechanical strength and low thermal expansion rate.

Thin films of silica have been made by many methods, including evaporation, sputtering, chemical vapor deposition (CVD), atomic layer deposition (ALD), sol-gel techniques and wet chemical precipitation methods. These methods generally deposit the silica layers non-selectively on all exposed surfaces of a flat substrate.

In some applications silica is only wanted on certain areas of a flat substrate. In such cases, lithography and selective chemical etching might be used to remove silica from areas where it is not wanted. However, when surface is not planar, lithography is not applicable.

### SUMMARY

The present disclosure provides for self-aligned deposition of silica films on non-planar surfaces of substrates, such as particles utilized in solar cell applications. It overcomes the limitations of the previously-used patterning methods described above.

The source of the silica is one or more precursors in a fluid contacting the substrate. In some embodiments, the fluid is a gas or vapor phase, while in others the fluid may be a liquid.

The silica precursors may be molecules containing both silicon and oxygen, or they may be separate silicon- and oxygen-containing molecules. In some embodiments, the silica precursors are alkoxysilanols. Preferred alkoxysilanols include tris(tert-butoxy)silanol and tris(tert-pentoxy)silanol.

The invention exploits differences in the growth rate of silica on different substrates. In particular, silica films were found to grow on certain catalytically active substrates, such as aluminum, titanium, zirconium, hafnium and copper, as well as the oxides and nitrides of these metals. In contrast, under the same conditions, no silica was deposited on catalytically inactive materials, including silicon oxide itself, silicon nitride, carbon and many organic materials, such as dyes, polymers and plastics.

This discovery can be applied to making improved solar cells, particularly those of the dye-sensitized type. In this case, the catalytically active material in the solar cell is typically titanium dioxide, while the catalytically inactive material can be an absorbing dye, such as an organic dye, or a ruthenium complex, or an inorganic semiconductor.

### BRIEF DESCRIPTION OF THE DRAWINGS

FIG. 1 is a schematic cross section of a conventional dye-sensitized solar cell;

FIG. 2 is a schematic cross section of a dye-sensitized solar cell in accordance with certain embodiments;

FIG. 3 is a schematic illustration of an apparatus with the selective deposition of silica can be carried out in accordance with certain embodiments;

FIG. 4 is a plot of the thickness of silica deposited on the catalytic surface of titanium dioxide as a function of substrate temperature in accordance with certain embodiments;

FIG. 5 shows energy-dispersive X-ray (EDX) analysis of the silica deposited uniformly inside a multilayer structure of nano-particles of TiO₂ in accordance with certain embodiments;

FIG. 6 is a transmission electron microscopic (TEM) image of a titanium dioxide (TiO₂) nanoparticle covered by a silica film in accordance with certain embodiments;

FIG. 7 is the chemical formula of a dye used in a dye-sensitized solar cells in accordance with certain embodiments; and

FIG. 8 is a plot of current-voltage curves for dye-sensitized solar cells made in accordance with certain embodiments of the invention and a control cell made in accordance with conventional techniques. It also includes the internal photoelectron collection efficiencies (IPCE) of the cells.

### DETAILED DESCRIPTION

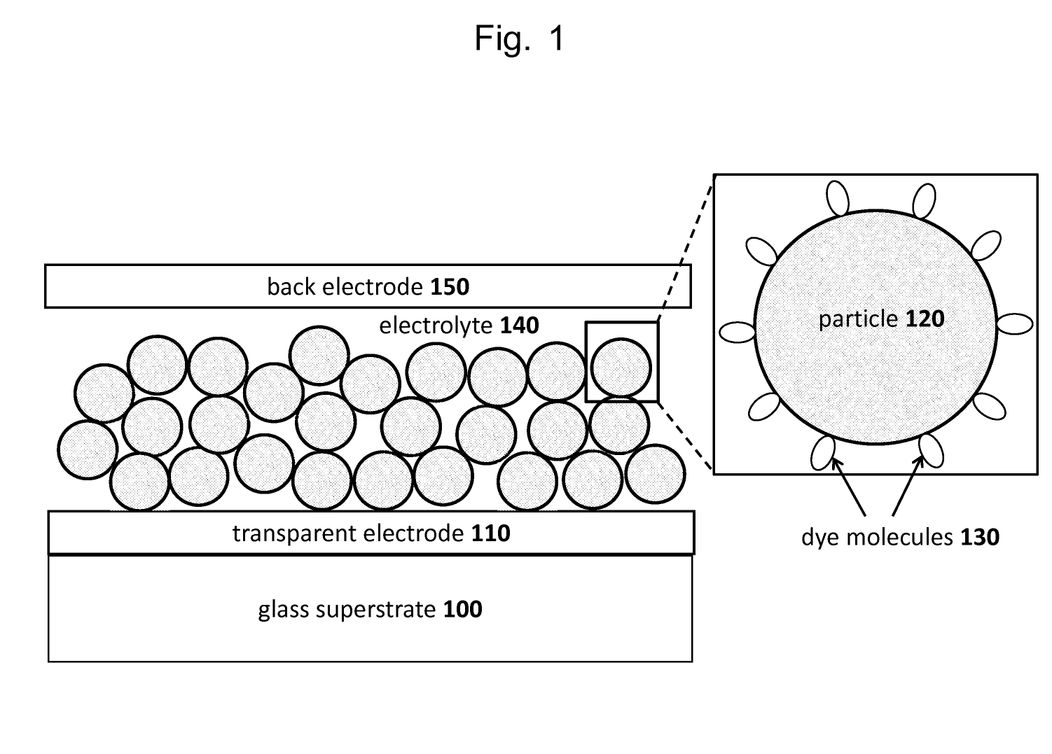

Dye-sensitized solar cells have a structure shown schematically in FIG. 1. A glass superstrate 100 is covered with a transparent conducting oxide layer 110, such as fluorine-doped tin oxide (SnO₂(F) or FTO), or indium-tin oxide (In₂O₃(Sn) or ITO). Multilayers of particles 120 (e.g., titanium dioxide nanoparticles) are coated with dye molecules 130 that absorb light and transfer electrons into the particles. The electrons, in turn, flow through the particles and into the transparent conductor 110. Electrons from the transparent electrode 110 flow through an external circuit (not shown) into the back electrode 150 to deliver power from the solar cell. After traversing the external circuit, electrons from the back electrode 150 enter the electrolyte 140 and travel to the dye 130 to replace the electrons that were photolyzed from the dye molecules into the particles.

In certain embodiments, the back electrode 150 serves as the cathode while the transparent electrode 110 and nanoparticles 120 serve as the anode.

The above-described flow of photoelectrons takes place in areas on the particles that are covered by dye molecules. The exposed areas of the particle surfaces that are not covered by dye molecules allow direct contact between the electrolyte and the particles. Some of the photoelectrons in the particles recombine with electrons from the electrolyte at these exposed areas of the surfaces of the particles that are not covered by dye molecules. These photoelectrons that recombine on the exposed areas of the particles do not traverse the external circuit. They represent a loss from the potential output of the solar cell because they do not deliver any power to the external circuit.

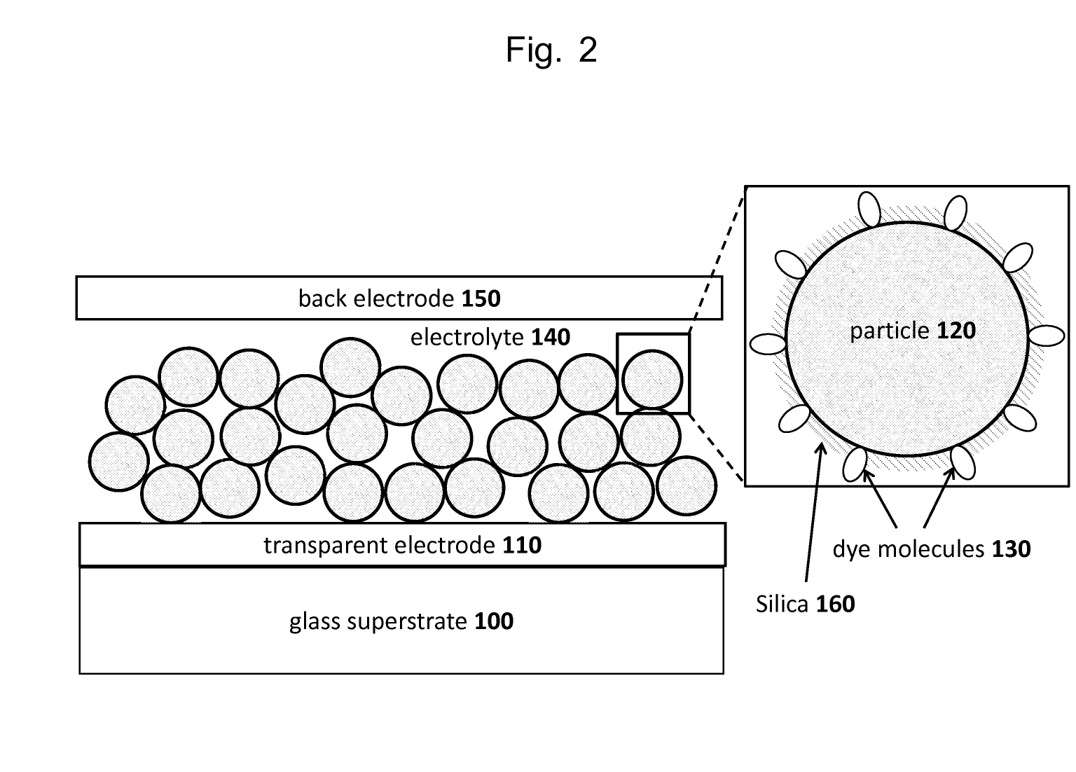

In certain embodiments, this unwanted recombination rate may be reduced or eliminated by selectively coating a thin layer of SiO₂ on the exposed areas of the particles where they are not covered by dye molecules. As shown in FIG. 2, a self-aligned layer of insulating silica is placed on the areas of the surface of the particles remaining exposed to the electrolyte after the dye has been adsorbed on the particles. It is important that the silica is self-aligned to lie only on the exposed surface between the dye molecules, but not between the dye molecules and the particles, nor between the dye molecules and the electrolyte. If the silica were to lie between the dye molecules and the particles, then it would inhibit the desired transfer of electrons from the dye to the particles. If the silica were placed between the electrolyte and dye molecules, then it would inhibit the desired transfer of electrons from the electrolyte to the dye. The placement of this self-aligned silica layer is indicated schematically in FIG. 2 as the dark hashed arcs between the dye molecules. This insulating silica inhibits or prevents the conduction of electrons from the surface of the particles into the electrolyte.

### Particles

There are a number of different particles that can be utilized for dye-sensitized solar cells. Exemplary particles include transparent semiconductors such as titanium dioxide (TiO₂), zinc oxide (ZnO), tin dioxide (SnO₂), nickel oxide (NiO) and the like. The surface of the particles can also be coated with a very thin layer (such as a monolayer or less) of a catalytically active insulator, such as aluminum oxide.

Suitable particles include surfaces that can selectively grow silica relative to the dye-surface. In certain embodiments, the particles have a surface that can catalytically grow silica. Preferably, the particles have a surface that can self-limit the growth of silica after a certain amount of silica has grown on the surface. Surfaces having a Lewis acid character can serve this purpose.

In certain embodiments, the particles may be replaced by other anode structures with high surface area, such as nanowires or nanotubes.

In certain embodiments, the particles may have an average particle size near 15 nanometers, such as 10 to 20 nanometers in diameter. In certain embodiments, the particles may be spherical, ellipsoidal, cylindrical, square, long or irregular in shape.

In certain embodiments, the particles can be deposited to form multilayers of particles, forming a film with thickness such as 10 or 25 or more micrometers.

There are numerous different ways to prepare suitable particles for use in dye-sensitized solar cells. For example, to produce titanium dioxide nanoparticles, methodologies described by Jeong et al., “A Convenient Route to High Area, Nanoparticulate TiO₂ Photoelectrodes Suitable for High-Efficiency Energy Conversion in Dye-Sensitized Solar Cells,” in the journal Langmuir, volume 27, pp. 1996-1999 (2011) and its supporting information can be utilized. Commercial samples of titanium dioxide nanoparticles can be obtained from companies such as Dyesol (Queanbeyan, New South Wales, Australia).

### Dyes

Any dye that is suitable for use in a dye-sensitized solar cell can be used in the manufacture of a silica self-aligned solar cell. Organic dyes such as are known and used in the solar cell arts will be apparent to those of skill in the art. Many different dyes can be utilized, such as the ones shown in the formulas below. The dye preferably does not catalyze the deposition of silica. Purely organic dyes are preferred, because they do not contain any metal that could act as a Lewis acid catalyst.

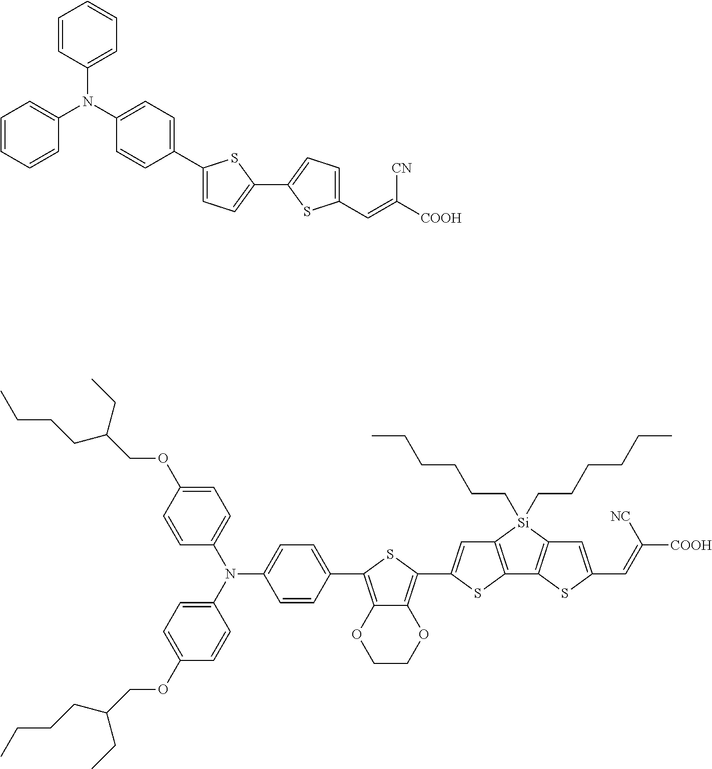 [SMILES: N#C/C(=C\c1ccc(-c2ccc(-c3ccc(N(c4ccccc4)c4ccccc4)cc3)s2)s1)C(=O)O ; CCCCCC[Si]1(CCCCCC)c2cc(/C=C(\C#N)C(=O)O)sc2-c2sc(-c3sc(-c4ccc(N(c5ccc(OCC(CC)CCCC)cc5)c5ccc(OCC(CC)CCCC)cc5)cc4)c4c3OCCO4)cc21]

### Selective Deposition of Silica

Different silica precursors can be utilized that allow selective, self-limited, and/or catalytic growth of silica over the particles described above. Suitable silica precursors include alkoxysilanol, alkoxysilanediol, and derivatives thereof. In certain embodiments, suitable silica precursors include tris(tert-alkoxy)silanols, such as tris(tert-butoxy)silanol and tris(tert-pentoxy)silanol. Another useful class of silica precursors include bis(tert-alkoxy)silanediols, such as bis(tert-butoxy)silanediol.

In certain embodiments, the silica deposition process can exhibit a self-limiting behavior, so that after a certain amount of growth, exposure to additional precursor vapor does not result in a thicker silica layer. For many applications, a silica layer of 1 or 2 nm may be sufficient to reduce the loss of photo-generated electrons through recombination reactions. It should be noted that this is entirely at variance with conventional chemical vapor deposition processes, in which the thickness of the deposited layer continues to increase with increasing reaction time. Accordingly, certain embodiments of the invention can provide well-controlled thicknesses of silica without any careful regulation of time of exposure or amount of vapor pressure. Furthermore, use of self-limited deposition reactions results in a uniform thickness of silica being deposited throughout a layer of nanoparticles. A uniform thickness of silica on all particles is highly desirable, because too thick a silica layer might cover the dye molecules and inhibit the desired transfer of electrons from the electrolyte to the dye. On the other hand, too thin a silica layer would not inhibit the undesired recombination reaction.

Further, in certain embodiments, silica coatings that are uniform, smooth, conformal and continuous over the entire exposed surface of catalytically active particles can be obtained. Even multi-layers of particles can be coated uniformly with silica by diffusion of the precursor vapor from outside the multilayer structure.

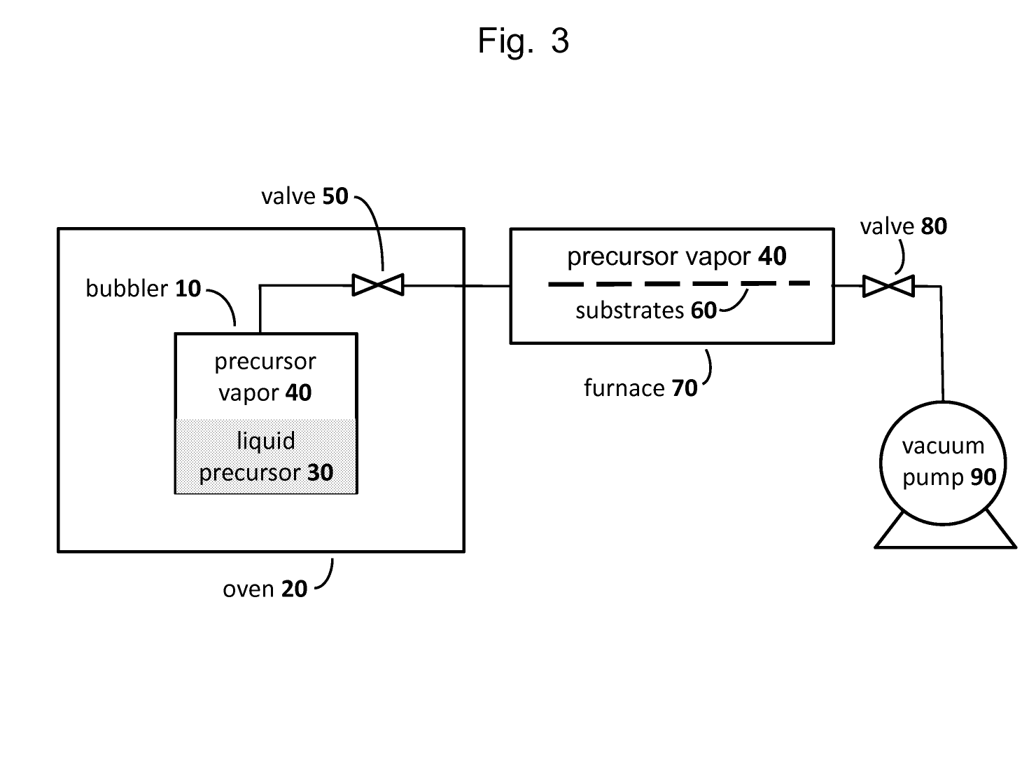

In certain embodiments, the selective deposition process can be carried out in an apparatus shown schematically in FIG. 3. For instance, substrate 60 containing dye-sensitized particles can be arranged inside a furnace 70 to be heated and exposed to vapors of a precursor for silica. Oven 20 can heat the liquid precursor 30 to obtain a precursor vapor 40. The precursor vapor 40 can be regulated by valve 50 to be introduced into the furnace 70. In certain embodiments, vacuum pump 90, regulated by valve 80, can provide a sub-atmospheric condition inside furnace 70 during deposition.

Other modifications and alternative embodiments will become readily apparent to one of ordinary skill in the art in light of the non-limiting examples that follow.

### EXAMPLE 1

In order to demonstrate some suitable particle materials that can allow selective, self-limited, catalytic growth of silica, various different flat substrates formed of different materials were utilized.

Test substrates were prepared of the following materials: aluminum metal (Al), amorphous aluminum oxide (Al₂O₃) deposited by atomic layer deposition (ALD) from trimethylaluminum and water at a substrate temperature of 200° C., and the anatase phase of titanium dioxide (TiO₂) deposited by ALD from titanium isopropoxide and water at a substrate temperature of 225° C. Substrates of zirconium dioxide and hafnium dioxide were prepared by ALD from tetrakis(ethylmethylamido)zirconium and tetrakis(ethylmethylamido)hafnium, respectively, reacting with water vapor at 250° C. Copper oxide, CuₓO, was prepared by oxidation of copper metal in ambient air. Substrates of silicon nitride (Si₃N₄) were prepared by plasma-activated chemical vapor deposition from silane and ammonia at 300° C., and silicon dioxide (SiO₂) by oxidation of a silicon wafer at 800° C. in air. Additional substrates were prepared of silicon with hydrogen-terminated surface (SiHₓ) by etching the SiO₂ layer from a silicon wafer with hydrogen fluoride solution in water.

Referring to FIG. 3, tris(tert-butoxy)silanol was placed in bubbler 10 that was heated inside oven 20. At an oven temperature of 95° C. the tris(tert-butoxy)silanol is a liquid 30 in equilibrium with its vapor 40 above it at a pressure of about 20 Torr. Samples of the substrates were placed inside a furnace connected to the source of vapor through stainless steel tubing and valve 50. The furnace is a cylindrical tube inside which the substrates are placed on a half-cylinder substrate holder.

Silica deposition was carried out by the following steps: (1) substrates 60 were placed in the furnace 70, valve 50 was closed and valve 80 was opened to evacuate the air from the furnace, down to the base pressure of the vacuum pump 90, around 0.01 Torr. After a sufficient time, about 15 minutes, the temperature of the furnace reached a stable value, set at values between 120° C. and 190° C. in a series of experiments. (2) Valve 80 was closed to isolate the substrates from the vacuum pump 90. (3) Valve 50 was opened for periods from 1 to 5 seconds and then closed, after which time the pressure of tris(tert-butoxy)silanol vapor in furnace 70 increased to a value around 1 Torr. (4) After an additional reaction time, between 5 seconds and 5 minutes, valve 80 was opened so that the vacuum pump removed unreacted tris(tert-butoxy)silanol vapor along with vapors of reaction byproducts. (5) In some experiments, the furnace temperature was increased to 350° C. for a period of one half hour, in order to anneal and densify the films. (6) Furnace 70 was turned off and cooled down to nearly room temperature, air was admitted to the furnace (through a valve not shown), and the samples were removed for testing. As will be recognized, the dose size, pressure, and other process parameters are dependent on the reactor size and therefore are to be adjusted accordingly for a given reactor and other process conditions.

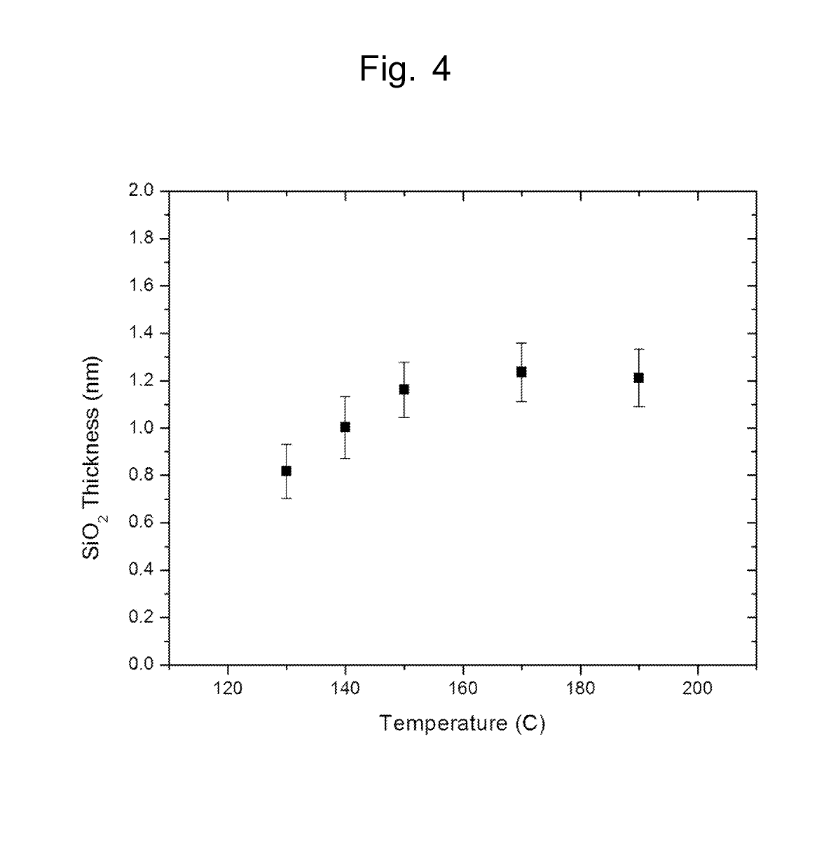

The thickness of any silica deposited on the substrates was measured by several techniques, including Rutherford backscattering spectroscopy (RBS), spectroscopic ellipsometry (SE), transmission electron microscopy (TEM) and low-angle X-ray reflectance (XRR). The absence of silica on some of the substrates was confirmed by X-ray photoelectron spectroscopy (XPS). The silica thickness increased when the precursor valve 50 was opened for times up to about 5 seconds, which was a convenient way to adjust the pressure of the silanol above the substrate. Longer valve-opening times gave higher final pressures of the silanol. The thickness of the silica was not increased further by increased times of exposure to the silanol vapor after closing valve 50 and before opening valve 80. These results show that the catalytic reaction is self-limited after a few seconds. The saturated thicknesses are recorded in Table 1 and plotted in FIG. 4 for titanium dioxide substrates at temperatures from 130 to 190° C.

TABLE 1

| | | Silica | Deposition | Method of |
|---|---|---|---|---|
| | Chemical | thickness | temperature | thickness |
| Substrate | Formula | nm | ° C. | measurement |
| aluminum metal | Al | 15 | 180 | SE |
| aluminum oxide | Al | 15 | 180 | SE |
| titanium dioxide | TiO₂ | <0.2 | 120 | RBS |
| titanium dioxide | TiO₂ | 0.8 | 130 | RBS |
| titanium dioxide | TiO₂ | 1.0 | 140 | RBS |
| titanium dioxide | TiO₂ | 1.1 | 150 | RBS |
| titanium dioxide | TiO₂ | 1.2 | 170 | RBS |
| titanium dioxide | TiO₂ | 1.2 | 190 | RBS |
| zirconium dioxide | ZrO₂ | 0.6 | 250 | RBS |
| hafnium dioxide | HfO₂ | 0.4 | 250 | RBS |
| copper oxide | CuₓO | 0.9 | 250 | XPS |
| silicon-hydrogen | SiH | 0 | 100-300 | XPS |
| silicon nitride | Si₃N₄ | 0 | 100-300 | XPS, SE |
| silicon dioxide | SiO₂ | 0 | 100-300 | SE |
| low-k dielectric | SiCₓO_{y}H_{z} | 0 | 100-300 | SE |
| glassy carbon | C | 0 | 200-300 | RBS |
| polyimide | | 0 | 100-300 | RBS |
| polytetrafluoro- | (CF₂)ₙ | 0 | 100-300 | RBS |
| ethylene | | | | |
| Viton^{tm} | | 0 | 100-200 | RBS |
| polycarbonate | | 0 | 100-150 | RBS |
| polyester | | 0 | 100-150 | RBS |
| polyethylene | (CH₂)ₙ | 0 | 100 | RBS |

As shown, FIG. 4 gives the self-limited thickness of silica deposited on the catalytic surface of the anatase form of titanium dioxide over a range of temperatures. As shown in Table 1, many other surfaces tested were found to have no catalytic activity toward the deposition of silica. This distinction between catalytic and non-catalytic materials provides the basis for self-aligned formation of silica on certain catalytic materials, while leaving adjacent non-catalytic materials completely free of silica.

It should be noted that previous experiments had shown that surfaces freshly exposed to vapors of highly reactive trimethylaluminum would catalyze deposition of silica layers to thicknesses of between 2 nm and 12 nm. It was understood that the catalytic activity of such surfaces was generated by the presence of this highly reactive material, and was not a property of the underlying substrate. Therefore it was a surprising discovery that a few ordinary surfaces have high catalytic activity for the deposition of silica even in the absence of any activation by trimethylaluminum.

### EXAMPLE 2

Dye-sensitized solar cells were prepared according to conventional procedures up through the loading of the dye. The starting substrate is flat glass coated commercially with electrically conductive fluorine-doped tin oxide (FTO), obtained from Pilkington North America, Toledo, Ohio. Their FTO product, TEC 15, has a sheet resistance of about 15 ohms per square. The FTO was cleaned by sonication in a detergent solution for ½ hour, followed by thorough washing with distilled water. The FTO was then coated with a thin TiO₂ layer by heating it at 70° C. for ½ hour in a 40 mM solution of TiCl₄, followed by washing with water and then ethanol. Nanocrystalline TiO₂ paste (TiO₂ nanoparticles with an average size 18 nm, DSL 18NR-T, from Dyesol) was then printed on the plate with a doctor blade, and dried at 25° C. for 2 hours. In order to attach the TiO₂ particles together more firmly, the plate was annealed in flowing air for 15 minutes at 375° C., then 15 minutes at 450° C., and finally for 15 minutes at 500° C. In order to scatter light more efficiently into the solar cell, a layer of larger TiO₂ particles was then applied by doctor blade (TiO₂ nanoparticles with 400 nm average diameter, WER4-0, from Dyesol) and annealed under the same conditions as the first TiO₂ nanoparticle layer. The resulting TiO₂ nanoparticle layer has a transparent layer of 18 nm diameter nanoparticles 13 micrometers thick on the FTO, with a scattering layer of 400 nm diameter nanoparticles 6 micrometers thick on top of the transparent layer. Thus these structures are thousands of particles deep. This structure was heated in a 40 mM solution of TiCl₄ at 70° C. for ½ hour, followed by heating at 500° C. for ½. These test structures were heated to 150° C. and treated with tris(tert-butoxy)silanol vapor for 5 minutes.

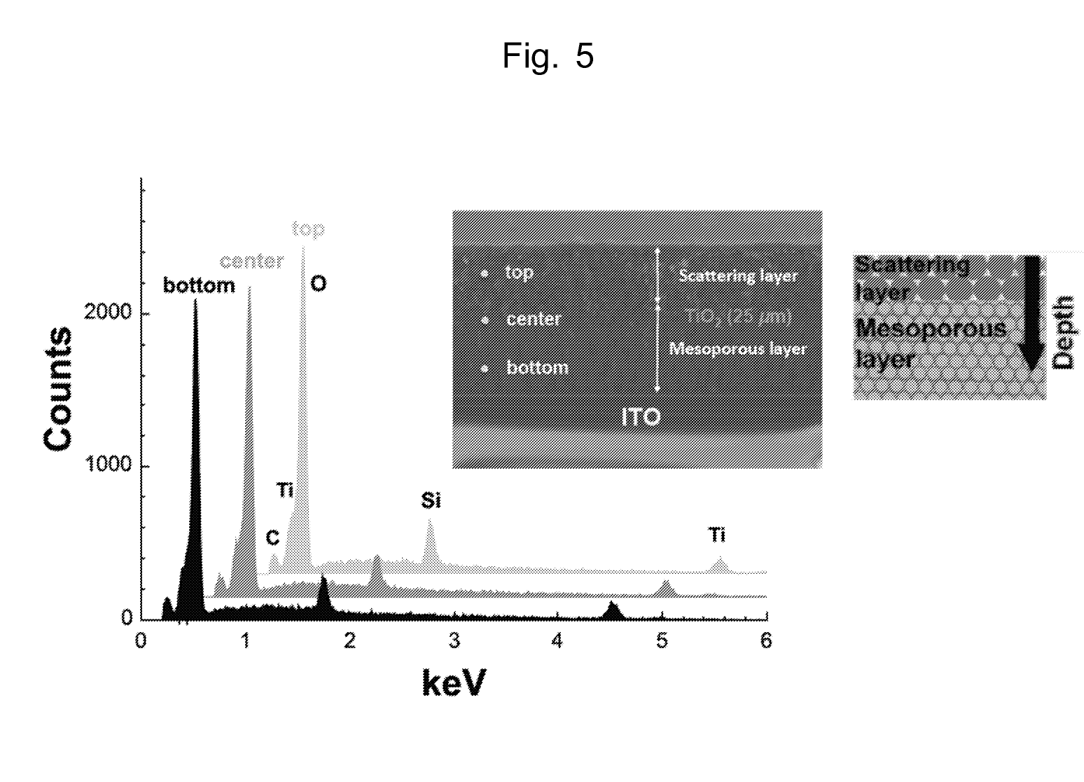

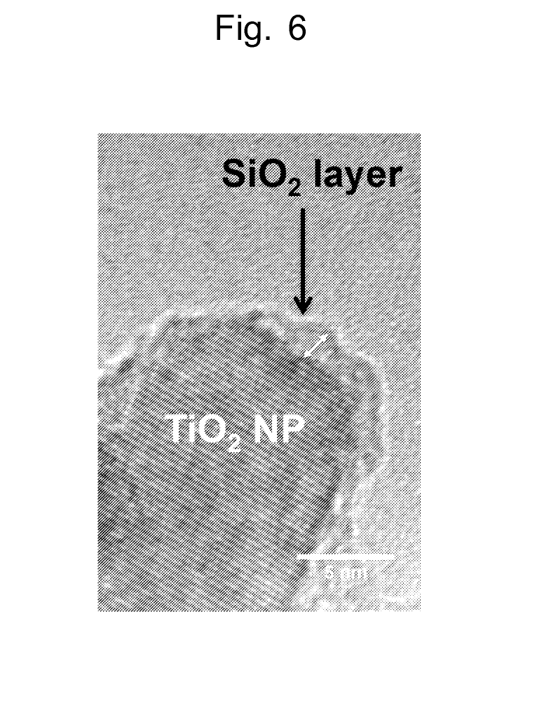

The silica content of these treated TiO₂ nanoparticle layers was measured by EDX on a cleaved cross section in a scanning electron microscope. The results, summarized in FIG. 5, show that silica was deposited fairly uniformly throughout the depth of these multilayers. Nanoparticles broken from this multilayer structure were examined by transmission electron microscopy. The resulting image in FIG. 6 shows a crystalline TiO₂ nanoparticle (indicated by the observed parallel planes of atoms) covered by an amorphous layer of silica, which has no ordered atomic structure. The silica layer is a little over 1 nanometer thick, in agreement with the measurements on a planar surface of TiO₂ in FIG. 4.

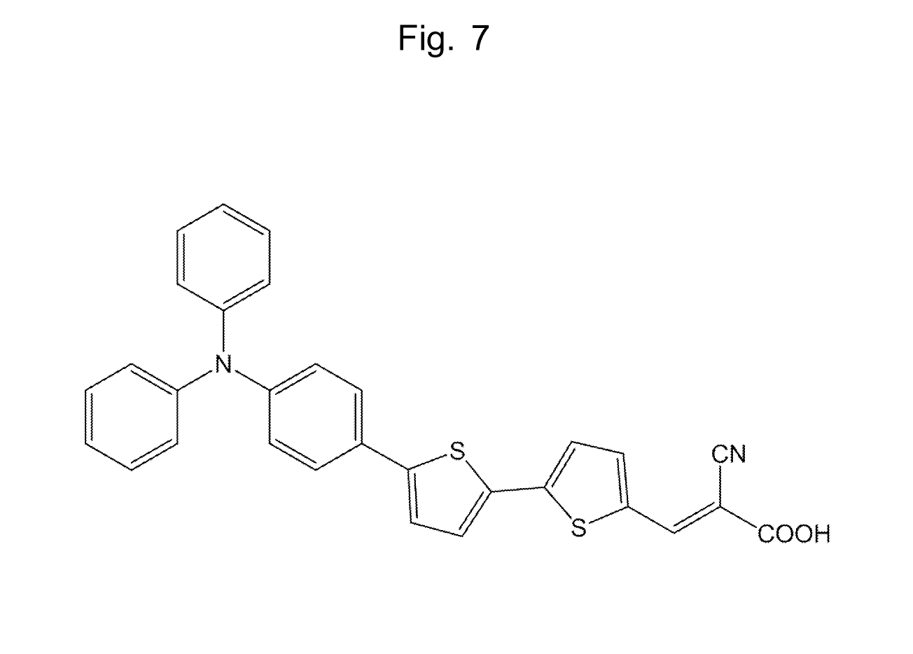

Additional samples of multilayers of TiO₂ nanoparticles were prepared. Next, organic dye molecules were adsorbed onto the TiO₂ multilayers from a 0.3 mM solution for 1 day, after which the plates were rinsed and dried under a nitrogen gas atmosphere. The dye, whose chemical formula is shown in FIG. 7, may be prepared by the method described by Thomas et al. in the journal Chemistry of Materials, volume 20, pp. 1830-1840 in 2008. Up to this point, these preparative steps are the same as those commonly used in the preparation of dye-sensitized solar cells. The next step is the special self-aligned deposition of silica according to an embodiment of the invention. The samples were exposed to tris(tert-butoxy)silanol vapor at an initial pressure of about 1 Torr as in Example 1 for 5 minutes at substrate temperatures of 140° C. (sample # 1) and 150° C. (sample # 2). A control sample received no silanol exposure. Once the silica deposition was completed, the partially-completed solar cells were cooled to near room temperature before their removal from the deposition chamber. The devices were kept in a controlled dry nitrogen environment after the silica deposition until the remainder of the solar cell construction was completed. This handling procedure protected the dye from contamination and/or oxidation by the ambient air. Electrolyte and back cathodes were then applied by methods known in the art. Platinized cathodes were prepared by drilling 0.3 mm holes in clean FTO glass plates and drop-casting a 5 mM solution of H₂PtCl₆ in ethanol on the plates. After drying, the cathode plates were heated in air at 380° C. for ½ hour. The cells were then assembled by placing a patterned 60-micrometer-thick Surlyn polymer film (Surlyn-1702, DuPont) between a platinized cathode plate and a dye-loaded, self-aligned silica-coated anode plate. A pre-cut hole in the Surlyn film defined the area that would be filled by electrolyte. This assembly was placed on a hotplate at 90° C. long enough to melt the polymer and seal the anode and cathode plates together. Exposed areas of each electrode were connected to indium-coated copper wires with silver-filled conductive epoxy that was cured at 110° C. for 40 minutes. An iodide electrolyte (0.60 M 1,2-dimethyl-3-propylimidazolium iodide (98%, TCI), 0.05 M I₂ (99.8%, Aldrich), and 0.50 M 4-tert-butylpyridine (99%, Aldrich) in acetonitrile (99.5%, Aldrich)) was vacuum-loaded into the cell through the hole in the cathode plate, which was then sealed by heating a Surlyn film and a micro cover glass over the hole.

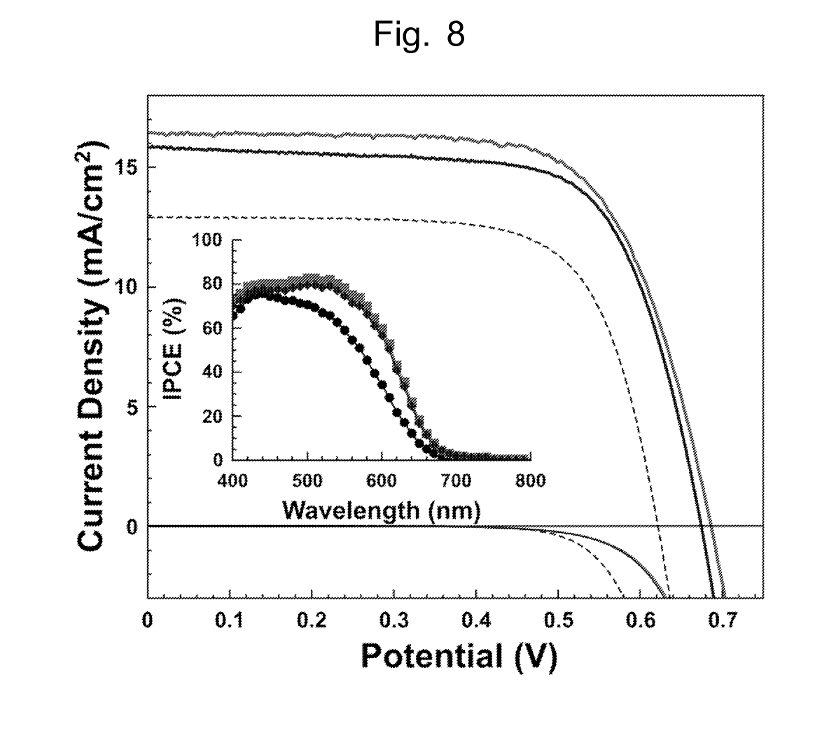

Illuminated current-voltage curves are shown in FIG. 8 for solar cells #1 (highest line) and #2 (next-highest line), as well as the prior art control solar cell (lowest, dashed line). The silica deposition increased both the short-circuit current and the open-circuit voltage, giving a conversion efficiency of 5.94%, for the solar cell #1 coated at 140° C. according to the invention, compared to the prior art reference efficiency of 4.36%. Thus the solar cells with self-aligned silica coatings on the TiO₂ have solar conversion efficiencies more than 1.36 times higher that of control cells without the silica. The internal photoelectron collection efficiencies (IPCE) of the silica-treated cells are higher at all wavelengths than the control cell, as shown in the inset to FIG. 8. The electron lifetimes and diffusion lengths were also markedly increased by the presence of the self-aligned silica.

It is recognized, of course, that those skilled in the art may make various modifications and additions to the processes of the invention without departing from the spirit and scope of the present contribution to the art. Accordingly, it is to be understood that the protection sought to be afforded hereby should be deemed to extend to the subject matter of the claims and all equivalents thereof fairly within the scope of the invention.

What is claimed is:

1. A dye-sensitized solar cell comprising:
one or more dyes;
an electrolyte;
a cathode; and
an anode comprising silica;
wherein the silica is located between the surface of the anode and the electrolyte, and not between the one or more dyes and the electrolyte, and not between the one or more dyes and the surface of the anode.

2. The solar cell of claim 1, wherein the anode further comprises one or more particles that have a diameter less than about 100 nm.

3. The solar cell of claim 1, wherein the anode comprises materials selected from the group consisting of titanium dioxide, tin dioxide, zinc oxide and aluminum oxide.

4. The solar cell of claim 2, wherein the one or more particles are titanium dioxide.

5. The solar cell of claim 1, wherein the anode further comprises a transparent electrode.

6. The solar cell of claim 1, wherein the dyes comprise organic dyes.

7. The solar cell of claim 1, wherein the dyes are represented by the formula 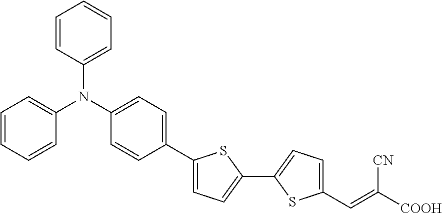 [SMILES: N#C/C(=C\c1ccc(-c2ccc(-c3ccc(N(c4ccccc4)c4ccccc4)cc3)s2)s1)C(=O)O]
or by the formula

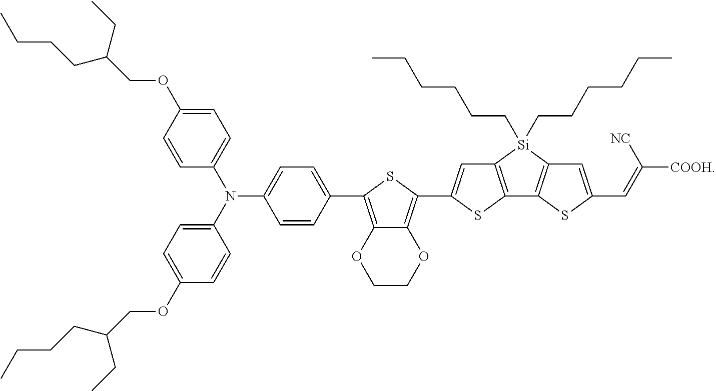 [SMILES: CCCCCC[Si]1(CCCCCC)c2cc(/C=C(\C#N)C(=O)O)sc2-c2sc(-c3sc(-c4ccc(N(c5ccc(OCC(CC)CCCC)cc5)c5ccc(OCC(CC)CCCC)cc5)cc4)c4c3OCCO4)cc21]

8. A method for forming a dye-sensitized solar cell of claim 1, the method comprising:
forming an anode coated with one or more dyes;
exposing the anode coated with one or more dyes to a silica precursor to form silica on portions of the anode that are not coated with the dyes;
providing an electrolyte and a cathode.

9. The method of claim 8, wherein the anode comprises particles having a diameter less than about 100 nm.

10. The method of claim 8, wherein the anode comprises materials selected from the group consisting of titanium dioxide, tin dioxide, zinc oxide and aluminum oxide.

11. The method of claim 9, wherein the particles are titanium dioxide.

12. The method of claim 8, wherein the anode further comprises a transparent electrode.

13. The method of claim 8, wherein the dyes comprise organic dyes.

14. The method of claim 8, wherein the dyes are represented by the formula 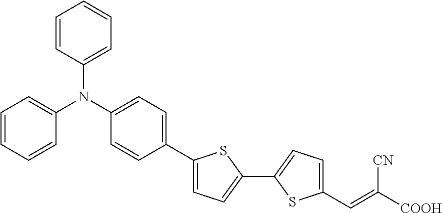 [SMILES: N#C/C(=C\c1ccc(-c2ccc(-c3ccc(N(c4ccccc4)c4ccccc4)cc3)s2)s1)C(=O)O]
or by the formula

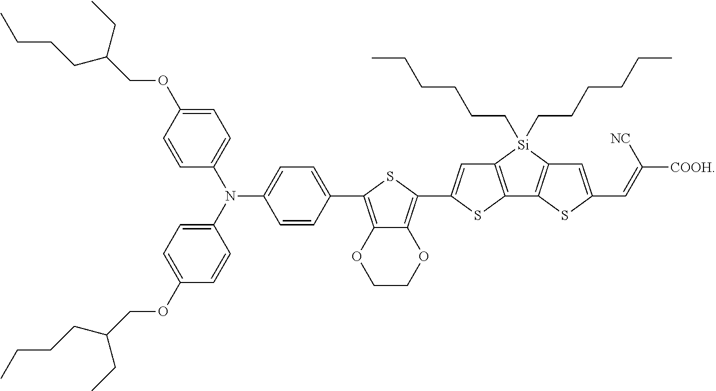 [SMILES: CCCCCC[Si]1(CCCCCC)c2cc(/C=C(\C#N)C(=O)O)sc2-c2sc(-c3sc(-c4ccc(N(c5ccc(OCC(CC)CCCC)cc5)c5ccc(OCC(CC)CCCC)cc5)cc4)c4c3OCCO4)cc21]

15. The method of claim 8, wherein a silica precursor is in the form of a vapor.

16. The method of claim 8, wherein a silica precursor is in the form of a liquid or a liquid solution.

17. The method of claim 8, wherein said exposing is carried out at a temperature less than about 200° C.

18. The method of claim 8, wherein said exposing is carried out at a temperature less than about 150° C.

19. The method of claim 8, wherein the silica precursor comprises an alkoxysilanol.

20. The method of claim 8, wherein the silica precursor comprises an alkoxysilanediol.

21. The method of claim 8, wherein the silica precursor is selected from the group consisting of tris(tert-butoxy)silanol and tris(tert-pentoxy)silanol.

22. The method of claim 21, wherein the silica precursor is tris(tert-butoxy)silanol.

23. The method of claim 21, wherein the silica precursor is tris(tert-pentoxy)silanol.
